(19) United States
(12) Patent Application Publication
(10) Pub. No.: US 2015/0195521 A1
(43) Pub. Date: Jul. 9, 2015

(54) CANDIDATE MOTION VECTOR SELECTION SYSTEMS AND METHODS

(71) Applicant: NVIDIA CORPORATION, Santa Clara, CA (US)

(72) Inventors: Zenjun HU, Shanghai (CN); Jianjun CHEN, Shanghai (CN); Stefan ECKART, Munich (DE)

(73) Assignee: NVIDIA CORPORATION, Santa Clara, CA (US)

(21) Appl. No.: 14/151,675

(22) Filed: Jan. 9, 2014

(51) Int. Cl. H04N 19/56; H04N 19/51; H04N 19/583

(52) U.S. Cl. CPC H04N 19/0066; H04N 19/00733; H04N 19/00696

(57) ABSTRACT

The present invention facilitates efficient and effective encoding and motion detection. A system and method can include: receiving graphics frame information; performing a motion vector analysis including candidate selection utilizing motion vectors that processing has previously been initiated for; and performing an encoding utilizing results of the motion vector analysis. A candidate motion vector is selected based upon balancing of performance and accuracy. The candidate motion vector can be associated with a macro-block that is spatially and temporally close to the left in the same row as the current macro-block. In one exemplary implementation, the candidate motion vector can be within 1 to 8 macro-blocks to the left of the current macro-block. A motion vector candidate selection process for a current macro-block can be performed in which a motion vector associated with another macro-block that has completed motion vector analysis is included as a candidate for the current macro-block.

### FIELD OF THE INVENTION

The present invention relates to the field of video encoding and motion detection.

### BACKGROUND OF THE INVENTION

Electronic systems and circuits have made a significant contribution towards the advancement of modern society and are utilized in a number of applications to achieve advantageous results. Numerous electronic technologies such as digital computers, calculators, audio devices, video equipment, and telephone systems facilitate increased productivity and cost reduction in analyzing and communicating data, ideas and trends in most areas of business, science, education and entertainment. Frequently, these activities involve video encoding and decoding. However, encoding and decoding can involve complicated processing that occupies valuable resources and consumes time.

### SUMMARY

The present invention facilitates efficient and effective encoding and motion detection. In one embodiment, a system and method includes receiving graphics frame information; performing a motion vector analysis including candidate selection utilizing motion vectors that processing has previously been initiated for; and performing an encoding utilizing results of the motion vector analysis. The motion vectors can be associated with macro-blocks to the left of a current macro-block. In one embodiment, the motion vector analysis includes: performing a motion vector candidate selection process for a current macro-block in which a motion vector associated with another macro-block that has completed motion vector analysis is included as a candidate for the current macro-block, and performing a motion vector determination process in which a motion vector is determined for the current macro-block. The current macro-block and the other macro-block can be included in the same horizontal row of macro-blocks. In one exemplary implementation, the candidate motion vector is associated with a macro-block that is spatially close to the current macro-block. The candidate motion vector can be within 1 to 8 macro-blocks to the left of the current macro-block. The candidate motion vector can also be temporally close to the current macro-block. In one embodiment, the candidate motion vector is selected based upon balancing of performance and accuracy.

### DESCRIPTION OF THE DRAWINGS

The accompanying drawings, which are incorporated in and form a part of this specification, are included for exemplary illustration of the principles of the present invention and not intended to limit the present invention to the particular implementations illustrated therein. The drawings are not to scale unless otherwise specifically indicated.

FIG. 1 is a block diagram of an exemplary encoding architecture in accordance with one embodiment of the present invention.

FIG. 2A is a block diagram of one exemplary depiction of image movement in accordance with one embodiment of the present invention.

FIG. 2B is a block diagram of an exemplary 16 pixel by 16 pixel frame macro in accordance with one embodiment of the present invention.

FIG. 3 is a block diagram of exemplary frames and motion vectors in accordance with one embodiment of the present invention.

FIG. 4 is another block diagram of exemplary frames and motion vectors in accordance with one embodiment of the present invention.

FIG. 5 is a block diagram of yet other exemplary frames and motion vectors in accordance with one embodiment of the present invention.

FIG. 6 is a block diagram of an exemplary motion vector analysis system in accordance with one embodiment of the present invention.

FIG. 7 is a flow chart of an exemplary graphics motion detection method in accordance with one embodiment of the present invention.

FIG. 8 is a flow chart of an exemplary motion vector analysis in accordance with one embodiment of the present invention.

FIG. 9 is a block diagram of an exemplary computer system upon which embodiments of the present invention can be implemented.

FIG. 10 shows another exemplary architecture that incorporates an exemplary video processor or graphics processor in accordance with one embodiment of the present invention.

FIG. 11 shows a diagram showing the components of an exemplary handheld device in accordance with one embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one ordinarily skilled in the art that the present invention may be practiced without these specific details. In other instances, well known methods, procedures, components, and circuits have not been described in detail as not to unnecessarily obscure aspects of the current invention.

The present invention facilitates effective and efficient motion vector analysis and encoding. In one embodiment, motion vectors associated with macro-blocks that are in spatially and temporally close proximity to a current macro-block are utilized as candidate motion vectors in a motion vector search for the current macro-block. In one exemplary implementation, motion vectors associated with any macro-blocks in the same row and to the left of the current macro-block can be selected and utilized as candidate motion vectors for the current macro-block. In one exemplary implementation, a candidate motion vector is selected based upon a balancing of accuracy and performance. The balancing can include proximity and completeness (e.g., begun processing to determine motion vector associated with a macro-block close to the current macro-block, completed processing to determine motion vector associated with a macro-block close to the current macro-block, etc.). It is appreciated the present invention can be utilized with a variety of configurations (e.g., video frames, streaming content frames, etc.) and formats (e.g., HDTV, H264, MPEG2, MPEG4, etc.). It is also appreciated that the present invention can be implemented to perform various analyses of pixel value changes. The results of the analysis can be forwarded for utilization in a variety of operations, including motion vector selection and encoding.

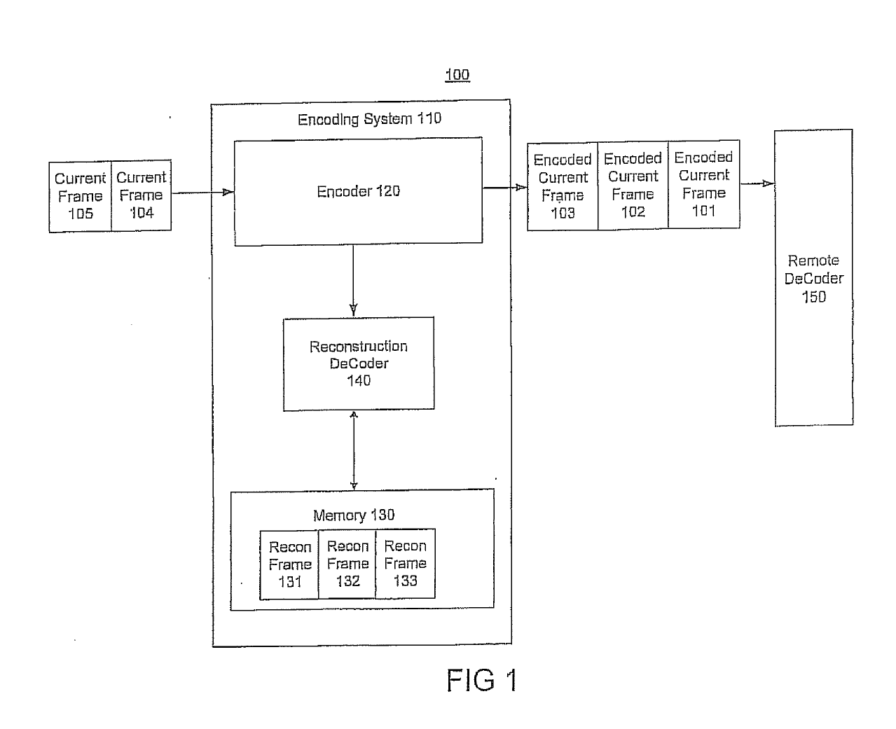

FIG. 1 is a block diagram of an exemplary encoding architecture 100 in accordance with one embodiment of the present invention. Encoding architecture 100 includes encoding system 110 and remote decoder 150.

Encoding system 110 receives current frames (e.g., current frames 104 and 105) encodes the current frames, and then forwards the encoded current frames (e.g., encoded current frames 101, 102 and 103 to remote decoder 150). Encoding system 110 includes encoder 120, reconstruction decoder 140 and memory 130. The encoder 120 encodes the frames and forwards them to remote decoder 150 and reconstruction decoder 140. Reconstruction decoder 140 decodes the frames and forwards them to memory 130 for storage as reconstructed frames 131, 132 and 133. In one exemplary implementation, the reconstructed frames 131, 132 and 133 correspond to encoded current frames 101, 102 and 103. The frames can include either encoded, reconstructed or raw pixel values corresponding to image presentation.

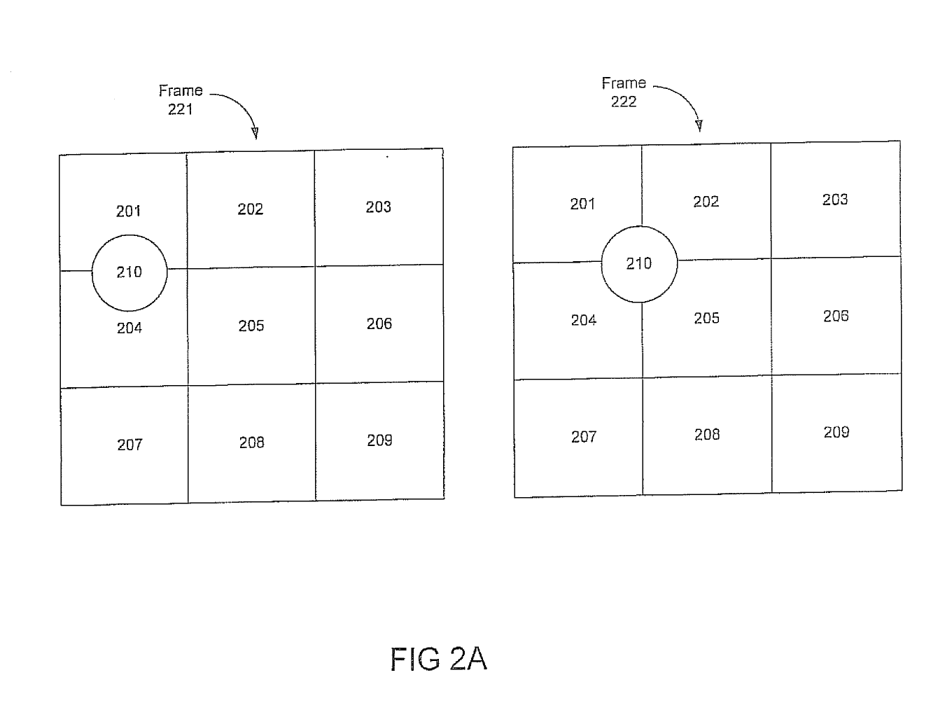

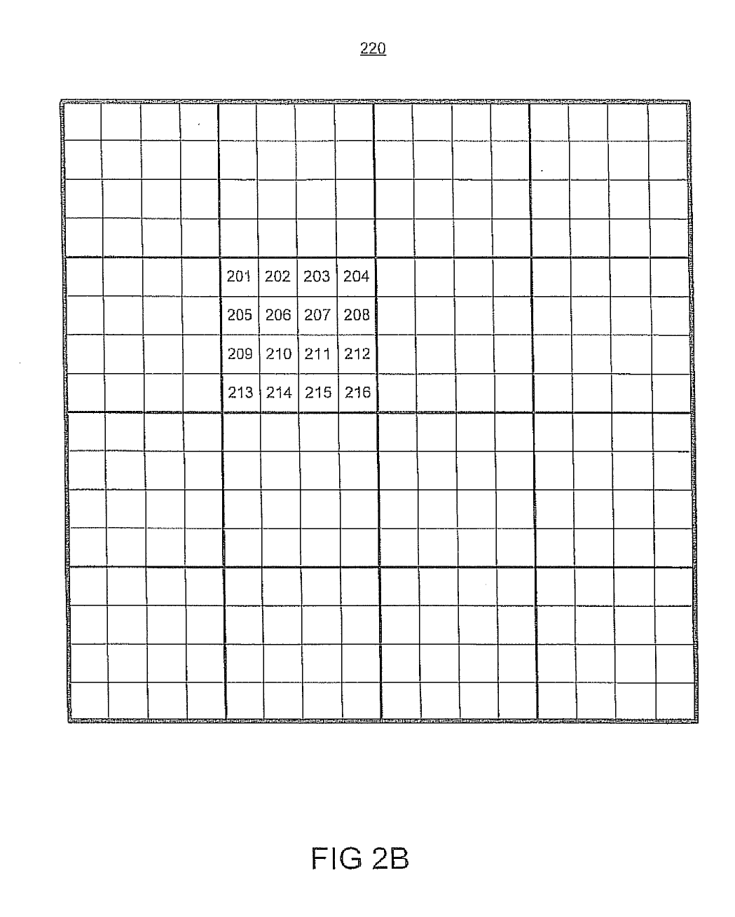

In one embodiment, as an image or object in one frame “moves” to a different corresponding location in a subsequent frame, the frames have similar characteristics (e.g., values associated with the image or object, etc.). The similar characteristics can prove beneficial in encoding operations. FIG. 2A is a block diagram of one exemplary depiction of image movement. The pixels 201 through 209 are some pixels associated with frames 221 and 222. In one exemplary implementation, frames 221 and 222 are similar to current frames 102 and 103 respectively. The other pixels associated with frames 221 through 222 are not shown so as not to unnecessarily obfuscate the invention. It is appreciated that the frames 221 through 222 can include a number of different pixel configurations and can be configured to be compatible with a variety of video frame formats (e.g., HDTV, MPEG, etc.). In frame 221 the ball image 210 is partially depicted by pixels 201 and 204. In frame 222 the ball image 210 “moves” to be partially depicted by pixels 201, 202, 204 and 205. A variety of values associated with the pixels change as the ball image movement is depicted by the pixels. For example, if pixels 202 and 205 depicted an image of grass in frame 221, the color value associated with the pixels would be the color of grass (e.g., green, etc.) with corresponding luminance and chrominance values. The color values associated with the pixels 201, 202, 204 and 205 in frame 222 would include the color of a ball (e.g., white, brown, etc.) with corresponding luminance and chrominance values when the ball image moved to be depicted by the pixels.

It is appreciated the pixels can be configured or arranged in a variety pixel group or sub-group associations. FIG. 2B is a block diagram of exemplary 16 pixel by 16 pixel macro-block 220. In one exemplary implementation, the 16 pixel by 16 pixel frame macro-block 220 includes sixteen 4 pixel by 4 pixel blocks, a 4 pixel by 4 pixel block comprising pixels 201 through 216. The present invention can be utilized to analyze the group or sub-groups of pixel association.

In one embodiment, establishing which corresponding respective macro-blocks of different frames are associated with motion characteristics beneficial to encoding involves motion vector identification and analysis.

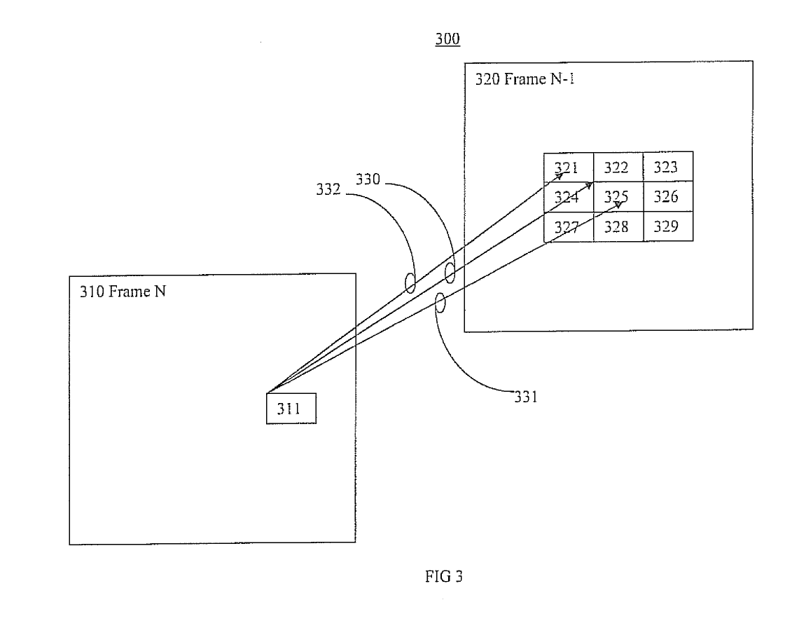

FIG. 3 is a block diagram of exemplary frames and motion vectors. Frame 310 includes macro-block 311 and frame 320 includes macro-blocks 321 through 329. In one embodiment, frame 310 is earlier or before frame 320 (e.g., frame 310 is displayed before frame 320, etc.). In one exemplary implementation, an object or image in frame 310 associated with macro-block 311 moves relative position or location in frame 320 and is associated with at least one of the corresponding macro-blocks 321 through 329. In one embodiment, a motion search engine utilizes a motion vector in determining and identifying association between macro-blocks of different frames. The identification of the association between the macro-blocks can be used to find an appropriate or best match for the current macro-block that will enable improved compressed image quality.

In one embodiment, a motion search engine starts with one or more candidate motion vectors and searches the candidate motion vectors. Optionally, it can also search motion vectors close to or surrounding the candidate motion vectors. With reference still to FIG. 3, in one exemplary implementation, motion vector 330 is a candidate motion vector and motion vectors 332 and 331 are close to or surround motion vector 330. Given the potential large and complex processing involved in finding a good or best motion vector, determining a good or appropriate candidate is a key factor in achieving good compression and better quality.

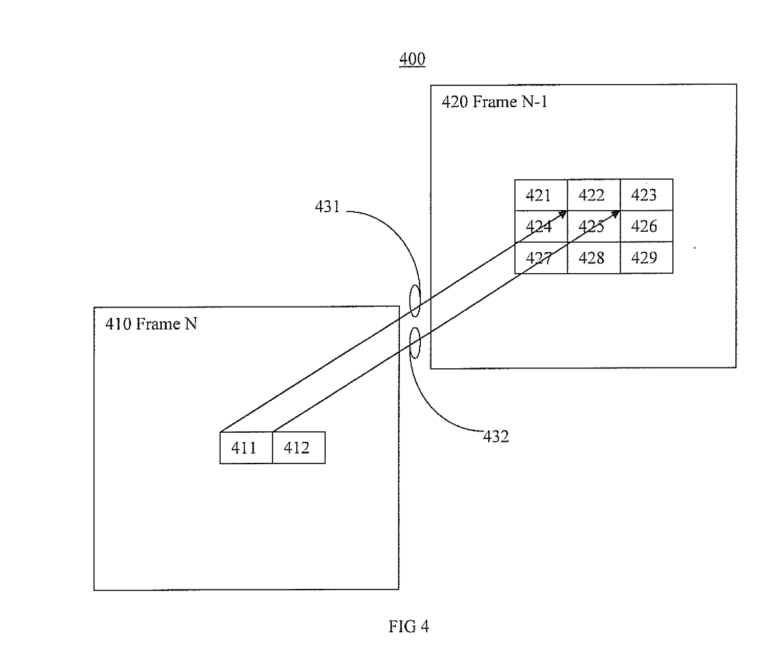

In one embodiment, a motion vector associated with a macro-block in close spatial and temporal proximity to the current macro-block is selected as a candidate vector. The proximity of the macro-blocks offer a relatively high degree of accuracy because the macro-blocks are likely very similar to one another including being associated with similar motion vectors. In one embodiment, a motion vector to the left of the current macro-block is selected as a candidate. FIG. 4 is another block diagram of exemplary frames and motion vectors. Frame 410 includes macro-block 411 and 412 and frame 420 includes macro-blocks 421 through 429. In one embodiment, frame 410 is earlier or before frame 420 (e.g., frame 410 is displayed before frame 420, etc.). In one exemplary implementation, an object or image in frame 410 associated with macro-block 412 moves relative position or location in frame 420 and is associated with at least one of the corresponding macro-blocks 421 through 429.

Motion vector 432 is a possible candidate motion vector for the current macro-block 412. The motion vector 431 is a motion vector for macro-block 411 (the macro-block to the left of macro block 412) and can also be utilized as a possible candidate motion vector for macro-block 411. In one exemplary implementation, due to the motion blocks spatial dependency or proximity, the motion vectors also typically exhibit close dependency or similarity. Thus, the motion vector 431 associated with macro-block 411 is a good candidate motion vector for macro-block 412 as a search start point. In one exemplary implementation, processing associated with motion vector 431 is started before processing associated with motion vector 432 and is determined or resolved before motion vector 432. Thus, motion vector 431 is available as a candidate before or faster than motion vector 432.

In one embodiment, the choice of another macro-block motion vector as a candidate motion vector for the current macro-block is a balancing between processing completion time and accuracy. The processing completion time and accuracy are usually related to the “closeness” of the other macro-block. It is appreciated that a motion search can be very time consuming and processing intensive, and the determining or finding a final motion vector can take a relatively large number cycles. In some embodiments and exemplary implementations, selecting a motion vector associated with a macro-block that is spatially and temporally extremely close to the current macro-block can typically provide a high level of accuracy but can potentially cause an impact or delay in motion search processing. If the spatially and temporally close macro-block is very close, the determination of its motion vector is less likely to be complete by the time the current macro-block motion vector candidate selection is ready to be initiated resulting in a stall or pause of the current motion vector search and determination. However, if the spatially and temporally close macro-block is not close enough it is less likely to be an accurate or appropriate candidate motion vector for the current block. Thus, the “other” macro-block selected to “provide” a motion vector as a candidate motion vector for a current macro-block can be selected based upon a proximity or closeness that allows both acceptable and appropriate accuracy and performance.

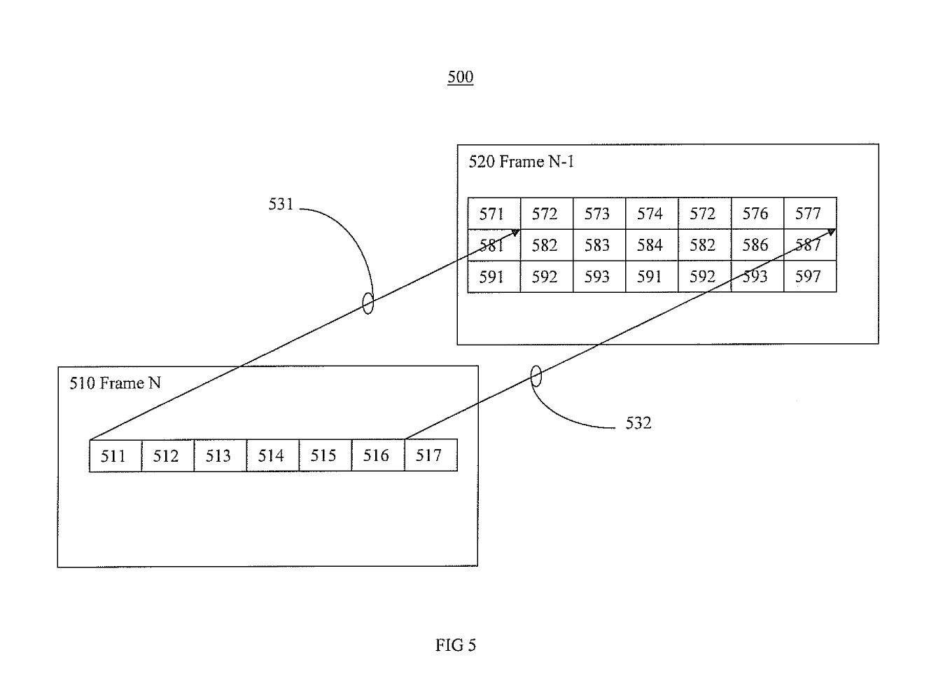

FIG. 5 is a block diagram of yet other exemplary frames and motion vectors. Frame 510 includes macro-blocks 511 through 517 and frame 520 includes macro-blocks 571 through 597. In one embodiment, frame 510 is earlier or before frame 520 (e.g., frame 510 is displayed before frame 520, etc.). In one exemplary implementation, an object or image in frame 510 associated with macro-block 517 moves relative position or location in frame 520 and is associated with at least one of the corresponding macro-blocks 571 through 597 (e.g., 577, etc.). In one exemplary implementation, motion vector 531 has been found or completed analysis before the motion search for the current macro-block 517 begins. In addition, given the close proximity of macro-block 511 to macro-block 516, motion vector 531 is almost the same quality candidate as a motion vector associated with macro-block 516. Thus, both or either motion vector 531 or motion vector 532 can be selected as candidate motion vectors for current macro-block 517.

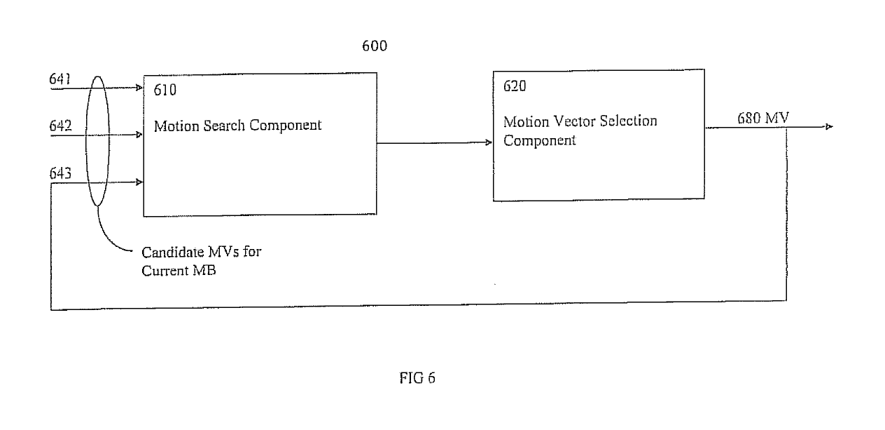

FIG. 6 is a block diagram of an exemplary motion vector analysis system 600. Motion vector analysis system 600 includes motion search component 610 and motion vector selection component 620. Motion search component 610 gathers several candidate motion vector inputs 641, 642 and 643 for a current motion block. Candidate motion vector input 643 for the current macro-block (e.g., similar to 412, 517, etc.) is a motion vector (e.g., similar to 431, 531, etc.) associated with a previously analyzed macro-block (e.g., 411, 511, etc.). The previously analyzed macro-block motion vector can be associated with a macro-block in close proximity to the left on the same row as the current macro-block. Motion vector selection component 620 analyzes the candidate motion vectors and selects an appropriate motion vector for the current macro block.

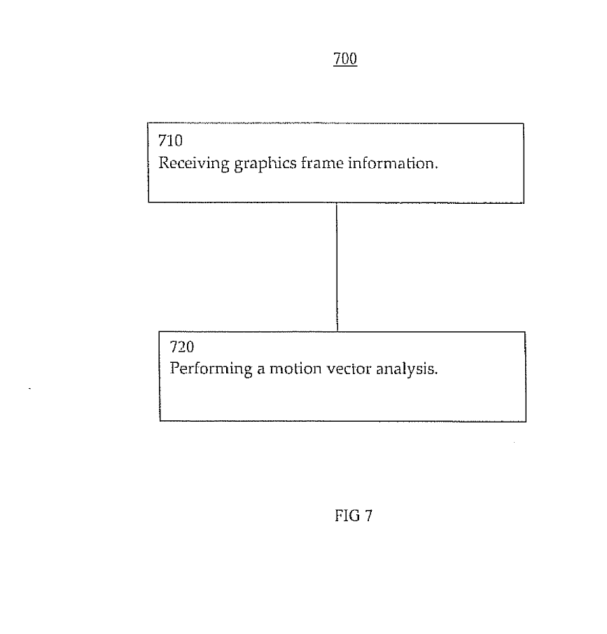

FIG. 7 is a flow chart of an exemplary graphics motion detection method 700 in accordance with one embodiment of the present invention.

In block 710, graphics frame information is received. The received frame information can include pixel information configured in macro-blocks.

In block 720, a motion vector analysis is performed. In one embodiment, the motion vector analysis includes candidate selection utilizing motion vectors that processing has previously been initiated for wherein the motion vectors are associated with macro-blocks to the left of a current macro-block. In one exemplary implementation, the candidate motion vector is associated with a macro-block that is spatially close to the current macro-block. The candidate motion vector can be associated with a macro-block that is temporally close to the current macro-block. The candidate motion vectors for the current macro-block can be associated with any macro-blocks in the same row and to the left of the current macro-block. The candidate motion vector can be selected based upon balancing of performance and accuracy.

In block 730, encoding is performed utilizing results of the motion vector analysis. The encoding can be graphics or video encoding.

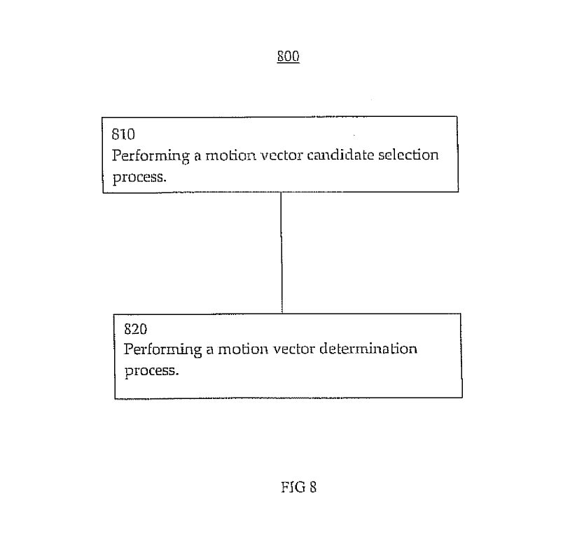

FIG. 8 is a flow chart of an exemplary motion vector analysis 800 in accordance with one embodiment of the present invention.

In block 810, a motion vector candidate selection process is performed for a current macro-block in which a motion vector associated with another macro-block that has completed motion vector analysis is included as a candidate for the current macro-block. The current macro-block and the other macro-block can be included in the same horizontal row of macro-blocks. In one embodiment, the candidate motion vector is associated with a macro-block to the left of the current macro-block. The candidate motion vector can be temporally and spatially close to the current macro-block. In one exemplary implementation, the candidate motion vector can be within 1 to 8 macro-blocks to the left of the current macro-block.

In block 820, a motion vector determination process is performed in which a best or appropriate motion vector is determined for the current macro-block.

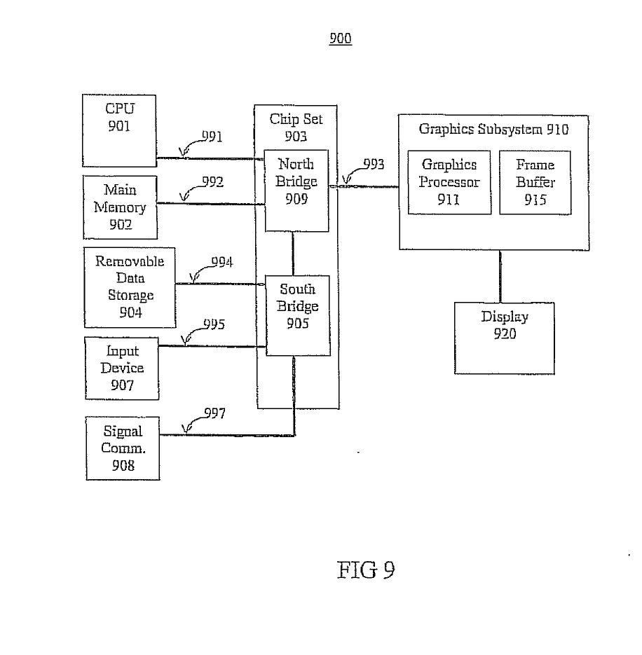

With reference to FIG. 9, a block diagram of an exemplary computer system 900 is shown, one embodiment of a computer system upon which embodiments of the present invention can be implemented. Computer system 900 includes central processor unit 901, main memory 902 (e.g., random access memory, etc.), chip set 903 with north bridge 909 and south bridge 905, removable data storage device 904, input device 907, signal communications port 908, and graphics subsystem 910 which is coupled to display 920. Computer system 900 includes several busses for communicatively coupling the components of computer system 900. Communication bus 991 (e.g., a front side bus) couples north bridge 909 of chipset 903 to central processor unit 901. Communication bus 992 (e.g., a main memory bus) couples north bridge 909 of chipset 903 to main memory 902. Communication bus 993 (e.g., the Advanced Graphics Port interface) couples north bridge of chipset 903 to graphic subsystem 910. Communication buses 994, 995 and 997 (e.g., a PCI bus) couple south bridge 905 of chip set 903 to removable data storage device 904, input device 907, signal communications port 908 respectively. Graphics subsystem 910 includes graphics processor 911 and frame buffer 915.

The components of computer system 900 cooperatively operate to provide versatile functionality and performance. Communications bus 991, 992, 993, 994, 995 and 997 communicate information. Central processor 901 processes information. Main memory 902 stores information and instructions for the central processor 901. Removable data storage device 904 also stores information and instructions (e.g., functioning as a large information reservoir, etc.). Input device 907 provides a mechanism for inputting information and/or for pointing to or highlighting information on display 920. Signal communication port 908 provides a communication interface to exterior devices (e.g., an interface with a network). Display device 920 displays information in accordance with data stored in frame buffer 915. Graphics processor 911 processes graphics commands from central processor 901 and provides the resulting data to video buffers 915 for storage and retrieval by display monitor 920.

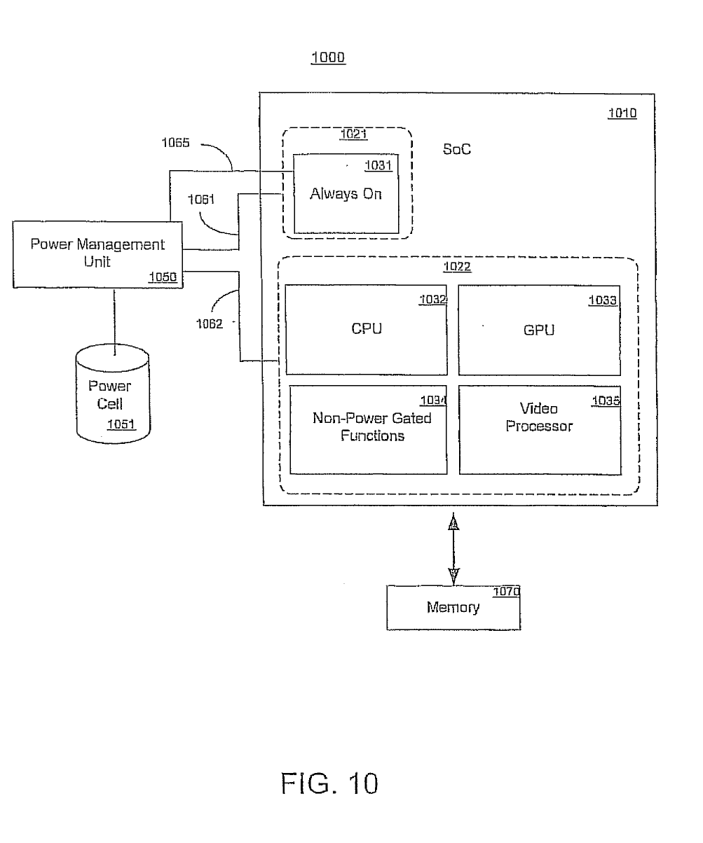

FIG. 10 shows another exemplary architecture that incorporates an exemplary video processor or graphics processor in accordance with one embodiment of the present invention. As depicted in FIG. 10, system 1000 embodies a programmable SOC integrated circuit device 1010 which includes two power domains 1021 and 1022. The power domain 1021 includes an “always on” power island 1031. The power domain 1022 is referred to as the core of the SOC and includes a CPU power island 1032, a GPU power island 1033, a non-power gated functions island 1034, and an instance of the video processor. The

FIG. 10 embodiment of the system architecture 1000 is targeted towards the particular intended device functions of a battery-powered handheld SOC integrated circuit device. The SOC 1010 is coupled to a power management unit 1050, which is in turn coupled to a power cell 1051 (e.g., one or more batteries, etc.). The power management unit 1050 is coupled to provide power to the power domain 1021 and 1022 via the dedicated power rail 1061 and 1062, respectively. The power management unit 1050 functions as a power supply for the SOC 1010. The power management unit 1050 incorporates power conditioning circuits, voltage pumping circuits, current source circuits, and the like to transfer energy from the power cell 1051 into the required voltages for the rails 1061 and 1062.

In the FIG. 10 embodiment, the video processor is within the domain 1022. The video processor provides specialized video processing hardware for the encoding of images and video. As described above, the hardware components of the video processor are specifically optimized for performing real-time video encoding. The always on power island 1031 of the domain 1021 includes functionality for waking up the SOC 1010 from a sleep mode. The components of the always on domain 1021 will remain active, waiting for a wake-up signal. The CPU power island 1032 is within the domain 1022. The CPU power island 1032 provides the computational hardware resources to execute the more complex software-based functionality for the SOC 1010. The GPU power island 1033 is also within the domain 1022. The GPU power island 1033 provides the graphics processor hardware functionality for executing 3-D rendering functions.

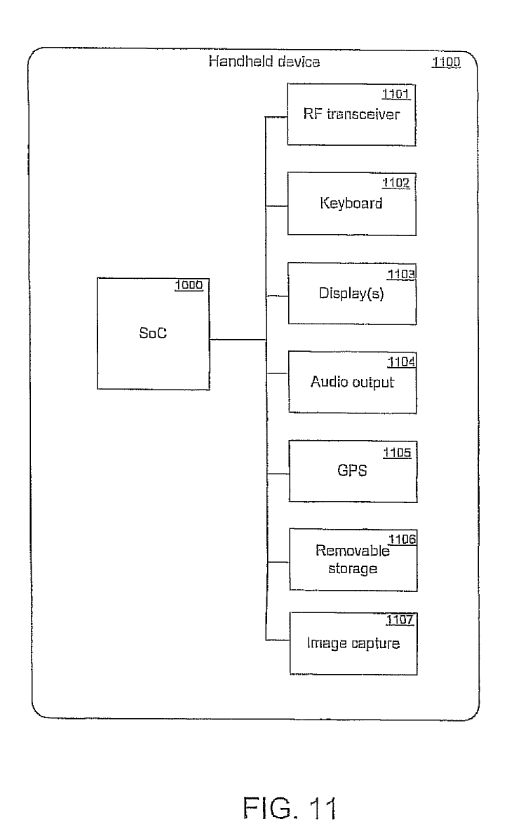

FIG. 11 includes a diagram showing the components of a handheld device 1100 in accordance with one embodiment of the present invention. As depicted in FIG. 11, a handheld device 1100 can include the system architecture 1000 described above in the discussion FIG. 10. The handheld device 1100 shows peripheral devices 1101-1107 that add capabilities and functionality to the device 1100. Although the device 1100 is shown with the peripheral devices 1101-1107, it should be noted that there may be implementations of the device 1100 that do not require all the peripheral devices 1101-1107. For example, in an embodiment where the display(s) 1103 are touch screen displays, the keyboard 1102 can be omitted. Similarly, for example, the RF transceiver can be omitted for those embodiments that do not require cell phone or WiFi capability. Furthermore, additional peripheral devices can be added to device 1100 beyond the peripheral devices 1101-1107 shown to incorporate additional functions. For example, a hard drive or solid state mass storage device can be added for data storage, or the like.

The RF transceiver 1101 enables two-way cell phone communication and RF wireless modem communication functions. The keyboard 1102 is for accepting user input via button pushes, pointer manipulations, scroll wheels, jog dials, touch pads, and the like. The one or more displays 1103 are for providing visual output to the user via images, graphical user interfaces, full-motion video, text, or the like. The audio output component 1104 is for providing audio output to the user (e.g., audible instructions, cell phone conversation, MP3 song playback, etc.). The GPS component 1105 provides GPS positioning services via received GPS signals. The GPS positioning services enable the operation of navigation applications and location applications, for example. The removable storage peripheral component 1106 enables the attachment and detachment of removable storage devices such as flash memory, SD cards, smart cards, and the like. The image capture component 1107 enables the capture of still images or full motion video. The handheld device 1100 can be used to implement a smart phone having cellular communications technology, a personal digital assistant, a mobile video playback device, a mobile audio playback device, a navigation device, or a combined functionality device including characteristics and functionality of all of the above.

Thus, the present systems and methods facilitate enhanced motion vector and encoding processing in an efficient and effective manner. The systems and methods enable balanced accuracy with increased performance in the selection and utilization of candidate motion vectors in a current macro-block motion vector analysis. A macro-block that is relatively close enough to allow both acceptable and appropriate accuracy and performance is selected.

Some portions of the detailed descriptions are presented in terms of procedures, logic blocks, processing, and other symbolic representations of operations on data bits within a computer memory. These descriptions and representations are the means generally used by those skilled in data processing arts to effectively convey the substance of their work to others skilled in the art. A procedure, logic block, process, etc., is here, and generally, conceived to be a self-consistent sequence of steps or instructions leading to a desired result. The steps include physical manipulations of physical quantities. Usually, though not necessarily, these quantities take the form of electrical, magnetic, optical, or quantum signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are associated with the appropriate physical quantities and are merely convenient labels applied to these quantities. Unless specifically stated otherwise as apparent from the following discussions, it is appreciated that throughout the present application, discussions utilizing terms such as “processing”, “computing”, “calculating”, “determining”, “displaying” or the like, refer to the action and processes of a computer system, or similar processing device (e.g., an electrical, optical, or quantum, computing device), that manipulates and transforms data represented as physical (e.g., electronic) quantities. The terms refer to actions and processes of the processing devices that manipulate or transform physical quantities within a computer system's component (e.g., registers, memories, other such information storage, transmission or display devices, etc.) into other data similarly represented as physical quantities within other components.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. The listing of steps within method claims do not imply any particular order to performing the steps, unless explicitly stated in the claim.

1. A graphics motion detection method comprising:
receiving graphics frame information;
performing a motion vector analysis including candidate selection utilizing at least one motion vector that processing has previously been initiated for wherein the at least one motion vector is associated with at least one macro-block to the left of a current macro-block; and
performing an encoding utilizing results of the motion vector analysis.

2. The graphics motion detection method of claim 1 wherein said motion vector analysis includes:
performing a motion vector candidate selection process for a current macro-block in which a motion vector associated with another macro-block that has completed motion vector analysis is included as a candidate for the current macro-block, wherein the current macro-block and the other macro-block are included in the same horizontal row of macro-blocks; and
performing a motion vector determination process in which a motion vector is determined for the current macro-block.

3. The graphics motion detection method of claim 1 wherein a candidate motion vector is associated with a macro-block that is 6 to the left of the current macro-block.

4. The graphics motion detection method of claim 1 wherein a candidate motion vector is associated with a macro-block that is spatially close to the current macro-block.

5. The graphics motion detection method of claim 1 wherein a candidate motion vector is associated with a macro-block that is within 1 to 8 macro-blocks to the left of the current macro-block.

6. The graphics motion detection method of claim 1 wherein a candidate motion vector is temporally close to the current macro-block.

7. The graphics motion detection method of claim 1 wherein a candidate motion vector is selected based upon balancing of performance and accuracy.

8. A computer system including a processor and memory, said processor operable to implement instructions stored on said memory comprising:
receiving graphics frame information;
performing a motion vector analysis including candidate selection utilizing at least one motion vector that processing has previously been initiated for wherein the at least one motion vector is associated with at least one macro-block to the left of a current macro-block; and
performing an encoding utilizing results of the motion vector analysis.

9. The computer system of claim 8 wherein said motion vector analysis includes:
performing a motion vector candidate selection process for a current macro-block in which a motion vector associated with another macro-block that has completed motion vector analysis is included as a candidate for the current macro-block, wherein the current macro-block and the other macro-block are included in the same horizontal row of macro-blocks; and
performing a motion vector determination process in which a motion vector is determined for the current macro-block.

10. The computer system of claim 8 wherein a candidate motion vector is associated with a macro-block that is 6 to the left of the current macro-block.

11. The computer system of claim 8 wherein a candidate motion vector is associated with a macro-block that is spatially close to the current macro-block.

12. The computer system of claim 8 wherein a candidate motion vector is associated with a macro-block that is within 1 to 8 macro-blocks to the left of the current macro-block.

13. The computer system of claim 8 wherein a candidate motion vector is temporally close to the current macro-block.

14. The computer system of claim 8 wherein a candidate motion vector is selected based upon balancing of performance and accuracy.

15. A computer readable medium for storing instructions including instructions to implement a graphics motion vector method comprising:
receiving graphics frame information;
performing a motion vector analysis including candidate selection utilizing at least one motion vector that processing has previously been initiated for wherein the at least one motion vector is associated with at least one macro-blocks to the left of a current macro-block; and
performing an encoding utilizing results of the motion vector analysis.

16. The computer readable medium of claim 15 wherein said motion vector analysis includes:
performing a motion vector candidate selection process for a current macro-block in which a motion vector associated with another macro-block that has completed motion vector analysis is included as a candidate for the current macro-block, wherein the current macro-block and the other macro-block are included in the same horizontal row of macro-blocks; and
performing a motion vector determination process in which a best motion vector is determined for the current macro-block.

17. The computer readable medium of claim 15 wherein a candidate motion vector is associated with a macro-block that is 6 to the left of the current macro-block.

18. The computer readable medium of claim 15 wherein a candidate motion vector is associated with a macro-block that is spatially close to the current macro-block.

19. The computer readable medium of claim 15 wherein a candidate motion vector is associated with a macro-block that is within 1 to 8 macro-blocks to the left of the current macro-block.

20. The computer readable medium of claim 15 wherein a candidate motion vector is temporally close to the current macro-block.
